(19) United States
(12) Patent Application Publication
(10) Pub. No.: US 2003/0220980 A1
(43) Pub. Date: Nov. 27, 2003

(54) Method and system for providing a computer network-based community-building function through user-to-user ally association

(76) Inventor: Jeffrey Robert Crane, Saratoga Springs, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 10/211,506

(22) Filed: Aug. 2, 2002

Related U.S. Application Data
(60) Provisional application No. 60/383,006, filed on May 24, 2002.

(51) Int. Cl. G06F 15/173; G06F 15/16

(52) U.S. Cl. 709/207; 709/225; 709/206

(57) ABSTRACT

The present invention features a system for building a reference hierarchy within a computer network-based community according to a user-to-user ally association function. Through this function, users in a community can associate themselves with other users as ally associates for the purposes of referring, validating, building an online community, and other benefits often found in real space environments. The present invention further features a group association function and a security blocking function that each utilize the ally association technology to involve other users. Finally, the present invention features a relationship stage defining function that allows parties involved in an online relationship to define a relationship and move through pre-defined stages.

### RELATED APPLICATIONS

This application claims priority to United States Provisional Application Serial No. 60/383,006, filed May 24, 2002, and entitled, “Method and System for Internet-Based Association Service.”

### BACKGROUND OF THE INVENTION

1. Field of the Invention

The present invention relates to network-based computer programs and services, namely Internet-Based programs and services. More particularly, the present invention relates to a method and system for providing a computer network-based communitybuilding function through the utilization of various user-to-user ally, referral, and association functions. This invention is particularly adapted for use in online dating, escort, and other similar services, but may also be applicable in other business arenas or functions.

2. Background and Related Art

The Internet has changed many aspects of society, including the way people meet each other. Whereas in the past, most people met only through their acquaintances, friends, and relatives, people can now meet others from anywhere in the world by participating in chat rooms or in on-line communities. While this has allowed people to greatly expand their scope of contacts, the internet has not yet proven to be an ideal way to meet people.

In offline or real space environments, most people meet through a third party such as acquaintances, friends, and relatives. When the two parties meeting for the first time have as a reference or a resource a third party friend, relative, or acquaintance, an element of trust in their relationship is more apt to be established. This initial bond can be very beneficial to the relationship, as many people form opinions based on the opinions of others whom they trust. The third party resource or reference may be enough to determine whether this relationship will be allowed to cultivate and grow, or abruptly end. Thus, the third party individual is capable of playing an important role in establishing relationships. Although meeting people through a third party resource is ideal, it is often limited only to the people one already knows or with those whom one has established a relationship.

Due to the proliferation and popularity of the Internet, an increasingly common way to meet and interact with people is through various online services. For example, many businesses, non-profit ventures, and individuals are using the Internet to disseminate information about themselves. These systems, which take advantage of Internet technology, serve to aid in the ability of people who otherwise would be at arms length, to form, establish, and build relationships.

In these systems, a database is typically searched to find at least another user of interest or who fulfills the need of the investigating party. However, prior art online systems have yet realized the potential of providing third party resources and references to the multitude of investigators searching for the perfect match.

Internet based contacts have become extremely popular and attractive to their users in the past several years and provide great opportunities for people to meet and interact with one another. However, as mentioned, online services suffer from several drawbacks, such as a lack trustworthiness. One of the primary drawbacks is their inability to recreate and provide, in an online setting or within cyberspace, the ability to utilize friends, acquaintances, and others in various ways to come in contact with someone of interest, as is done in the more traditional, offline settings. For example, it is not uncommon for two parties to come in contact with each other and form a relationship based on the referral or personal introduction from a friend or mutual acquaintance. The initiator of the contact is often unsure what kind of person this new contact is. Whereas in the past, one could ask friends and relatives about those one was interested in getting to know, in on-line relationships this is usually no possible. Most people use pseudo-names on the Internet to protect their identity and one is limited to reading self-written information about a person or to contacting that person directly. What is missing in most Internet-based relationships is the way to find out information about a person from a third party reference or referral.

### SUMMARY AND OBJECTS OF THE INVENTION

In accordance with the invention as embodied and broadly described herein, the present invention features a system for building a reference hierarchy within a computer network-based community. The system comprises a server system comprising one or more servers; a plurality of user profiles supported on the server system and corresponding to a plurality of users, wherein the plurality of users may take on one of several roles, namely an investigator, a profiler, or an ally depending upon whether the users are accessing and viewing other users' profiles, or the users' profiles are being accessed and viewed, or if the users are associated with other users, respectively; an ally association function, wherein one of the users is selectively associated with another user as an ally, wherein the ally association function is activated when an investigator initiates a request to become an ally associate of a profiler upon viewing the feature profile of the profiler, the profiler having the ability to accept or decline the request, thus being able to control the allies associated with the profiler, wherein the acceptance serves to associate the investigator with the profiler as an ally, as well as to associate the profiler with any allies of the investigator, thus creating a hierarchy of allies to said profiler; and an ally profile posted on the feature profile of the profiler, wherein the ally profile comprising an access link to a feature profile of the ally, identification of and an access link to any allies of the investigator ally, and a subjective rating and characterization of the profiler as provided by the investigator ally.

The present invention further features a computer network-based user-to-user ally association system comprising: a server system comprising one or more servers; a plurality of client computing devices in communication with the server system to comprise a network-based computer system, wherein the plurality of client computing devices correspond to a plurality of users, and wherein the plurality of users may take on one of several roles, as discussed and identified above; a computer-readable medium containing instructions for controlling the network-based computer system to execute an ally association function, wherein a user is associated with another user as an ally, and wherein the computer-readable medium comprises code for directing a computer to: support a plurality of user profiles corresponding to the plurality of users; display a feature profile of a profiler to an investigator; receive a request from the investigator to become an ally associate of the profiler upon viewing the feature profile; send the request to the profiler for approval, the profiler having the ability to accept or decline the request in order to control the allies associated with the profiler; receive a response from the profiler, the response comprising the decision of the profiler; upon acceptance, associate the investigator as an ally of the profiler, as well as associate the profiler with any allies of the investigator to create a hierarchy of allies to said profiler; display an ally profile on the feature profile of the profiler, wherein the ally profile comprises an access link to a feature profile of the ally, identification of and an access link to any the allies of the investigating ally, and a subjective rating and characterization of the profiler provided by the investigating ally; and proliferate the association function through other user-to-user ally associations to build a reference and witnessing hierarchy within the computer basednetwork.

The present invention further features a security and group blocking function wherein a user may block another user from accessing or viewing his/her profile. This block can be shared with other users in the community, preferably amongst allies, thus putting these other users on notice that a particular user has been blocked. The user-to-user ally association technology provides for this ability.

The present invention further features a relationship stage defining function that allows users to begin a relationship on a pre-defined level and move to successive levels and advance the relationship as appropriate. To advance, one party sends a next level notifier to the other party involved in the relationship. If the other party agrees, then that party responds by sending a reciprocal next level identifier to the initial sending party and the relationship advances. If the other party does not feel the same, they can ignore the notifier or send back a notifier that the current stage of the relationship is fine. Each stage comprises pre-defined rules of both appropriate and inappropriate behavior. The relationship stage defining function makes it very easy for parties to express themselves without having to do so with words. In other words, the relationship stage defining function of the present invention allows a relationship to be defined and advance without having to have the often dreaded “talk.”

While the methods and processes of the present invention have proven to be particularly useful in the area of online dating services, those skilled in the art can appreciate that the methods and processes can be used in a variety of different applications and in a variety of different areas of manufacture to yield operational and beneficial ally association services or elements within a community of computer network users.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a representative system that provides a suitable operating environment for use of the present invention;

FIG. 2 illustrates a general network-based system in which the technology of the present invention may be implemented;

FIG. 3 illustrates a flow diagram showing the process of establishing and setting up the ally association technology according to an exemplary embodiment of the present invention;

FIG. 4 illustrates a flow diagram showing generally how the ally association technology of the present invention is implemented and utilized within a community of users;

FIG. 5 illustrates a flow diagram of an online dating service comprising the inventive components of the present invention, namely the ally association, group blocking, relationship stage defining, and group function technologies;

FIG. 6 illustrates an architectural layout of a feature profile existing within an online dating service showing allies of the profiler to the first degree;

FIG. 7 illustrates an architectural layout of a feature profile existing within an online dating service showing allies of the profiler to the second and nth degree;

FIG. 8 illustrates how each member user or profile within an online dating service is or may be associated with each other;

FIG. 9 illustrates a flow diagram of the relationship stage defining technology within an online dating service according to one embodiment of the present invention;

FIG. 10 illustrates a flow diagram of the group blocking technology within an online dating service according to one embodiment of the present invention; and

FIG. 11 illustrates a Web page comprising the ally association, shared block, plan of friendship, and group technology according to an exemplary embodiment of the present invention.

### DETAILED DESCRIPTION OF THE PREFERRED EMBODIMENTS

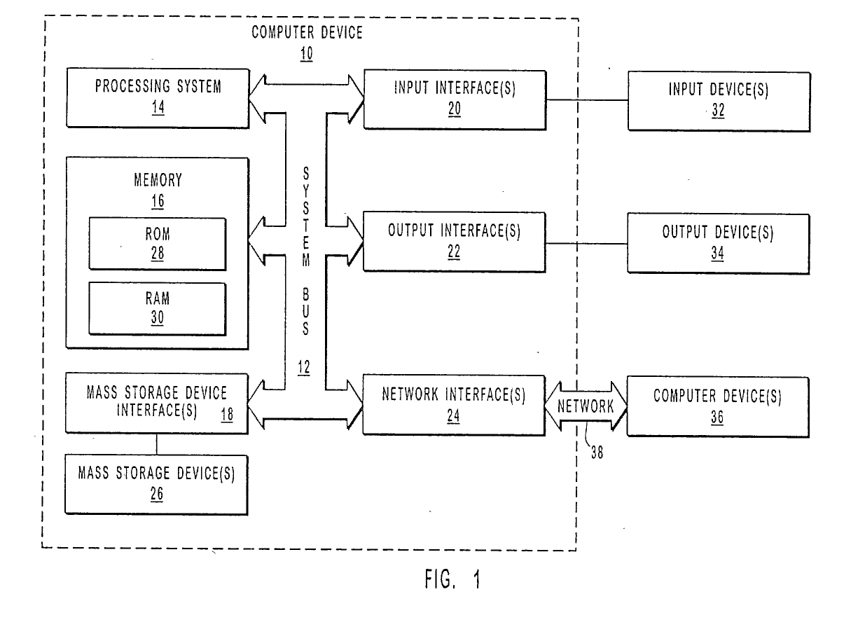

It will be readily understood that the components of the present invention, as generally described and illustrated in the figures herein, could be arranged and designed in a wide variety of different configurations. Thus, the following more detailed description of the embodiments of the system and method of the present invention, and represented in FIGS. 1 through 11, is not intended to limit the scope of the invention, as claimed, but is merely representative of the presently preferred embodiments of the invention.

The presently preferred embodiments of the invention will be best understood by reference to the drawings wherein like parts are designated by like numerals throughout.

The computer network-based community-building methods and processes of the present invention are particularly useful in the online dating, escort, and other similar industries. However, those skilled in the art will appreciate that the systems and methods of the present invention embrace a variety of different applications and industries to yield an increased ability to build, strengthen, and create peace of mind within a community of users and persons through a computer network-based user-to-user ally association function. Accordingly, in the disclosure and in the claims the term “community” shall refer to the aggregate of “users” and the one or more network-based environments or services hosting, supporting, or providing for said users. For example, such network-based environments or services may comprise online dating or escort services, various social service providers, professional service provider and management services, commercial development services, commercial sales services, and any other type of service in which a database of users or members is assembled and maintained. Moreover, the present invention is not limited to for-profit ventures, but may also be utilized in non-profit ventures, such as managed church groups, charities, local and federal governments, etc., and any others that assemble, maintain, and utilize a database of users for a specific purpose.

Also, in the disclosure and in the claims the term “user” shall refer generally to the members of an exclusive Internet Web site, those investigating or researching such sites, individual users within a network, members of a group, professional and other commercial providers, and generally, those individuals or companies that are part of or comprise a “community.”

The term “user profile” shall refer generally to the profile of a user, and a profile that is not currently or presently being accessed or viewed.

The term “feature profile” shall refer to the particular or specific user profile that is presently or currently being viewed or accessed by an investigator.

The term “profiler” shall refer to the user owning and featured on the featured profile. A user takes on the role of, or may be called, a profiler when that particular user's profile is accessed and viewed by an investigator.

The term “investigator” shall refer to a user in functioning in the role of searching profiles to access and view.

Finally, the term “ally” shall refer to the role one or more users take upon becoming associated with another user.

It is to be emphasized that these definitions of “users” simply illustrate the many possible roles that any one user and all users may take on depending upon the given situation and reference point. These definitions, along with the examples and embodiments set forth herein, are for discussion purposes only and are not to be construed as limiting in any way. One skilled in the art will recognize other variants and the several applications to which the present invention technology may be adapted.

Embodiments of the present invention take place in association with a computer device and/or system that is used to integrate one or more software modules created to enable the user-to-user ally association services or functions. These several components or modules exist to carry out the intended operations of the present invention technology. Accordingly, the following disclosure of the present invention is grouped into three subheadings, namely “Exemplary Operating Environment,” “User-to-user Ally Association Technology,” and “Exemplary Online Dating Service.” The utilization of these subheadings is for organizational purposes and convenience of the reader only and is not to be construed as limiting in any sense.

### Exemplary Operating Environment

FIG. 1, along with its corresponding discussion, is intended to provide a general description of a suitable operating environment in which the invention may be implemented. One skilled in the art will appreciate that the invention may be practiced by one or more computing devices and in a variety of system configurations, and particularly within in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the World Wide Web or the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

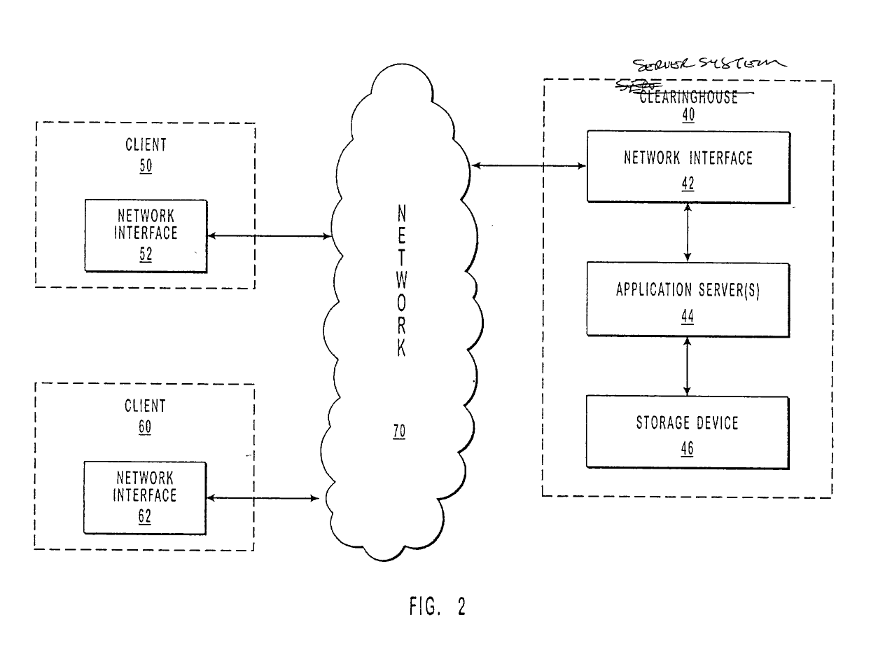

While those skilled in the art will appreciate that the invention may be practiced in networked computing environments with many types of computer system configurations, FIG. 2 represents an embodiment of the present invention in a networked environment that includes clients connected to a server via a network. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

Generally, FIG. 2 represents an exemplary embodiment of the present invention that enables the providing and execution of the several various community-building and management modules or services. Specifically, in FIG. 2, server system 40 represents a system configuration that includes one or more servers that are used to provide and execute the several various community-building functions through user-to-user ally association as described and claimed herein. By way of example, server system 40 may be a single server in cases where a single server can process and preserve the entire amount of information required to perform the methods of the present invention that are disclosed herein. Alternatively, server system 40 may be a conglomeration of servers that process and preserve a high volume of information.

In accordance with the illustrated embodiment, a customer or member or user may accesses a website in his/her own language to selectively seek out and gain information about other users or members through the assistance of and their association with still other select users or members.

The following is a discussion of the illustrated embodiment of the present invention, which includes a plurality of clients, illustrated as clients 50 and 60, connected to server system 40 across network 70 in order to provide the community-building services and functions described herein. Network 70 may include a wireless network, a local area network, and/or a wide area network.

With reference to FIG. 2, clients 50 and 60 include a network interface (respectively illustrated as network interfaces 52 and 62), such as a web browser or other network interface. Network interface 52 is a communication mechanism that allows client 50 to communicate with server system 40 via a network 70, such as the Internet, and to display information in the form of a web page on a display device at client 50. A browser allows for a uniform resource locator (“URL”) or an electronic link to be used to access the web page. Therefore, clients 50 and 60 may independently access a web page that enables the exchange of inflation with server system 40.

Server system 40 includes network interface 42, application servers 44, and storage device 46. Network interface 42 is a communication mechanism that allows server system 40 to communicate with one or more clients via network 70. Application servers 44 include one or more servers for processing and/or preserving information, and may be employed for providing and maintaining a web page that may be accessed by a client. Storage device 46 includes one or more storage devices for preserving information, such as demographic information, professional information, customer information, billing information, or any other type necessary to the methods and systems disclosed herein. Storage device 46 may be internal or external to application servers 44.

Thus, a customer or a user thereof at one of the clients, such as client 50, may access a web page maintained by one or more of the application servers 44 and access/submit information or communicate with other users. While the discussion above has presented a representative system configuration for implementing the present invention, those skilled in the art will appreciate that the methods of the present invention and processes thereof may be implemented in a variety of system configurations.

### User-To-User Ally Association Technology

In its highest level of abstraction, the present invention features a method and system for enabling user-to-user witnessing, referring, association, and verification (hereinafter referred to as “ally association technology”) within any computer network-based environment. As stated, the term “user” may be defined as any individual, entity, or group operating within a community. Specifically, a user may comprise members of an exclusive Internet Web site, those investigating or researching such sites, members of a group, professional and other commercial providers, those individuals within a network or network-based system, and/or generally those individuals or companies that are part of or comprise a community. Essentially, the present invention ally association technology, while unable to identify the myriad of possible community environments and types of users, is intended to encompass any system or environment in which one user seeks to, either directly or indirectly, investigate, search for, learn about, gain access to information about, contact, and/or communicate with another user. The present invention ally association technology also contemplates cross-community sharing, in which users within one community are capable of witnessing and associating with users of another community.

One of the primary benefits of the present invention user-to-user ally association technology is its community-building function, in which a “community” may be built, strengthened,.and otherwise formed or defined through its users and their association, interaction, and dealings with one another. This community-building function is accomplished in several ways, including through a system for building a reference hierarchy through the associations of the various users in the community.

The present invention contemplates that each member or user in the community may serve as an ally to any other user or member in the community upon the satisfaction of certain criteria discussed below, and that each ally may also have his or her own user profile that may be viewed as a feature profile. Thus, a profiler may simultaneously be an ally, and an ally may simultaneously be a profiler within the community. An ally, as defined herein, is a user associated with another user according to the user-to-user ally association software technology as provided herein. One exemplary, and preferred, ally association is the Friendly Witness^{SM} brand ally association as provided by CoolSaints.com, L.C. of Orem, Utah.

By allowing each user to selectively associate themselves with one another through the ally association, several advantages are realized, such as a large network of interwoven relationships where the level of communication as well as the comfort level are increased, a greater sense of trust between users in the community, a greater ability to meet and interact with several users, and a naturally more vibrant and active community as a result of the many interwoven relationships or associations. Several other benefits are made possible, which will be made apparent from the discussion herein. As such, the present invention technology and these resulting benefits provide a unique paradigm shift from prior art systems in which users within a community, and particularly an online community, play a less active or less involved and somewhat secondary role in the strengths, characteristics, spirit, and overall sense of the community. In the present invention, a much more active and tight knit community is achieved, as explained below.

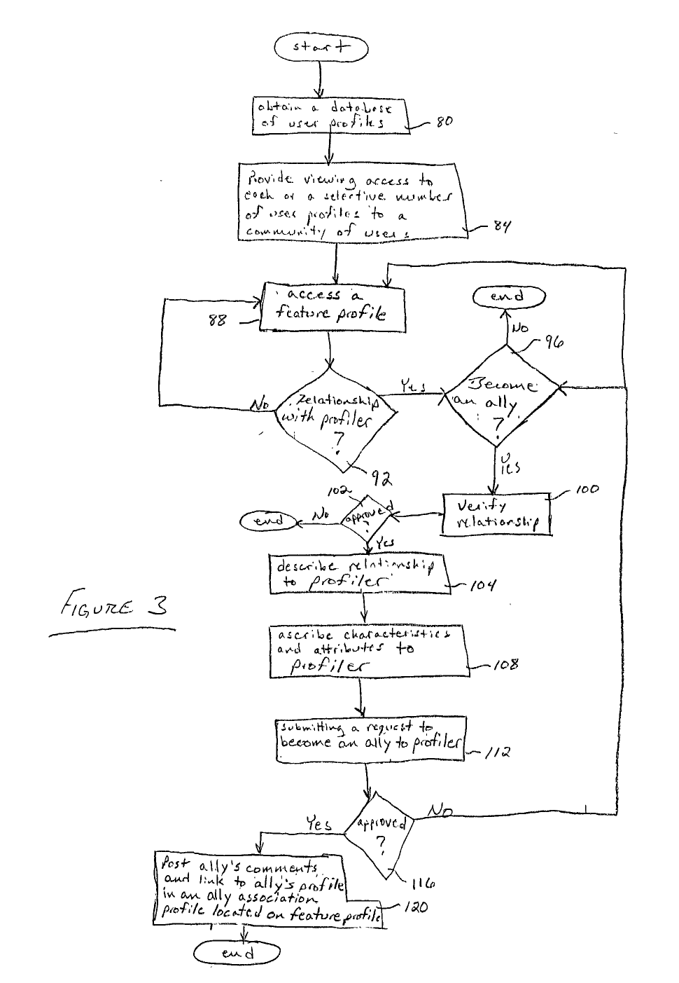

With reference to FIG. 3, shown is a flow diagram depicting the process of allowing an investigator to become an ally to a profiler. With this goal in mind and until established as an ally, the investigator may be defined as a prospective ally. First, the present invention requires that a database of user profiles be obtained 80, each corresponding to a respective user, and that each user within the community be given limited access and viewing rights to each profile or a select number of user profiles within the community. Upon setting Up and establishing a community, a prospective ally accesses and views 88 a feature profile of a profiler using some type of search function or address identifier that takes the user directly to that particular user's main profile page, such as a user name that may be typed into a search engine. Preferably, an investigator will request to become an ally with a profiler whom it is determined 92 that they have a relationship with already. For example, an investigator and a prospective ally could become an ally to a relative, a friend, an acquaintance, a business associate, or any other individual or entity with whom they have previously formed a relationship with. In this case, if no relationship exists, the investigator may continue his/her search until a profiler is found with whom they do have a relationship. However, this is not limiting as the present invention contemplates the possibility of an investigator becoming an ally to a profiler with whom they have not formed any prior relationship.

Once a profiler's feature profile is accessed 88 by the prospective ally, and a relationship between the two is established 92, the prospective ally selects a prompt to become an ally 96. If not, the process ends. If the prospective ally wishes to continue, the prospective ally may be asked to verify 100 the relationship with the profiler. This may simply be identifying from a list the type of relationship existing between the prospective ally and the profiler. If the relationship is not verified 102, the session ends. If the relationship is verified 102, the prospective ally may continue on to provide information about the profiler. The types of information provided may be a description 104 of the profiler, ascribing or rating 108 the characteristics and attributes of the profiler, or any other type of information pertaining to the profiler. This inflation may be provided to the prospective ally as a list in a drop down menu, wherein the prospective ally may select the appropriate selection. The present invention contemplates the use of any system or format allowing the prospective ally to submit information about the profiler.

Upon completion of providing information about the profiler, the prospective ally submits 112, and the system receives, a request to become an ally to the profiler. At this stage, the profiler determines 116 whether to approve or deny the request. If denied, the prospective ally may try again to become 96 an ally to the profiler at a later time, or the investigator and prospective ally may continue on by accessing another user's profile and repeating the above-described process. If the request to become an ally is approved, the prospective ally becomes an ally to the profiler and an ally profile is automatically added to or posted on the profiler's feature profile 120. Preferably, the ally profile will include a picture of the ally, a link to the ally's feature profile, the rating of the profiler by the ally, and any other additional information provided by the ally as applicable. This process may be repeated for any number of prospective allies and is described further below in the context of an online dating service.

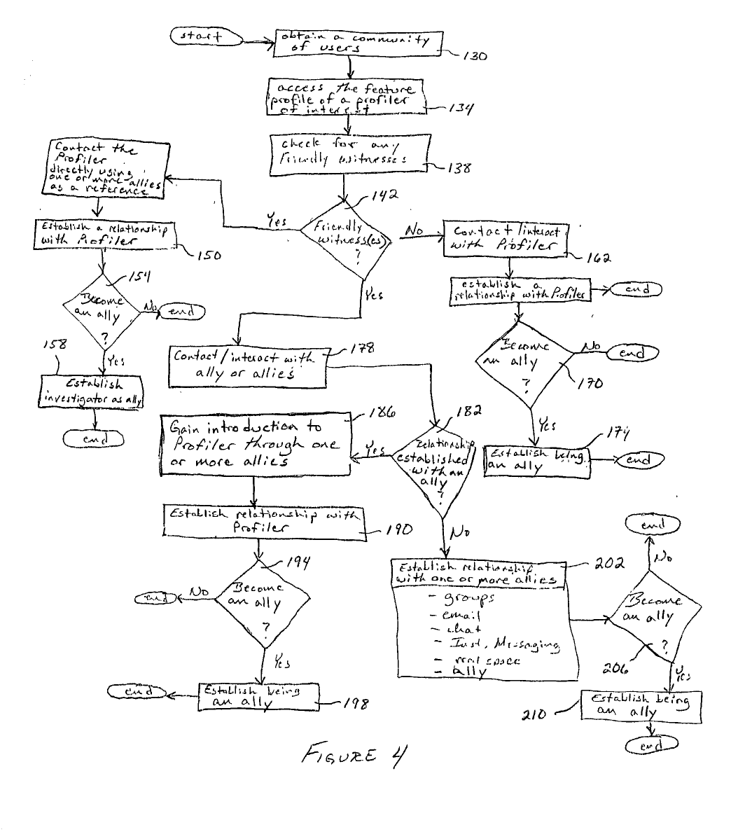

With reference to FIG. 4, shown is a flow diagram illustrating generally how the ally association technology of the present invention is implemented and utilized within a community of users. Specifically, FIG. 4 illustrates that a community of users is obtained 130, wherein each user, acting in the role of an investigator at this time, is given limited access rights to access 134 the user profiles of other users within the community, and particularly those of interest. An investigator can search through a community of users for various reasons. For example, a user may be looking for help with a project, may be interested in finding a group to participate in, or may be looking for an individual to date and interact with on a social level, etc. The possibilities are numerous and are each contemplated herein. FIG. 4 illustrates that the present invention system provides several ways users can contact, interact, and establish relationships with other users within the community.

Specifically, as an investigator accesses 134 a feature profile of a user of interest (which now takes on the role of a profiler), the investigator may check 138 to see if there are any allies of the profiler. One of the primary functions of an ally, among other things, is to establish that that profiler is accurate in their descriptions and self assessments, as well as to assure others that the profiler is who they say they are. In addition, allies serve to provide investigators a third-party resource that may be contacted to gain information and insight about the profiler or used to gain trust with the profiler. There are several advantages, benefits, and incentives for each user within the community to associate and align themselves with one or more other users through an ally association. These will be apparent from the discussion herein.

Upon accessing the profiler's feature profile, an investigator will quickly be able to determine 142 whether the profiler has any allies or not. If there are no allies present, then the present invention system functions much the same as prior art systems, wherein the investigator may either end the session and continue on to other user profiles or the contact the profiler directly 162 using any available means, such as email, etc. If direct contact is made, the investigator may establish a relationship 166 with the profiler through the investigator's own unilateral efforts. In addition, the investigator may request 170 to become an ally to the profiler. If agreed upon, the investigator is established 174 as an ally to the profiler through the process described in FIG. 3.

If the investigator accesses the profiler's feature profile and discovers 142 that there are indeed allies of the profiler existing on the feature profile, the investigator may either contact 146 the profiler directly, using the name of one of the allies as a reference, or the investigator may contact 178 one or more of the allies. If the investigator contacts 146 the profiler directly, the investigator may establish a relationship 150 with the profiler as desired, and/or may request to become an ally 154 to the profiler. If the profiler agrees to allow the investigator to become an ally, then the investigator is established 158 as an ally according to the process described in FIG. 3.

An investigator may contact 178 one or more of the profiler's allies for one of two reasons: either to establish a relationship with the ally or to establish a relationship with the profiler through an already existing relationship with the ally. Thus, as an investigator accesses a profiler's feature profile, and allies are present, it is first determined 182 whether the investigator has any type of relationship with any one or all of the allies. If no relationship exists, the investigator may establish a relationship 202 with one or more of the allies by contacting and interacting with the allies through email, chat, instant messaging, etc., or a relationship may be established by becoming an ally to the profiler's ally, again, according to the process described in FIG. 3.

If it is determined 182 that a relationship does indeed exist between the investigator and one or more of the profiler's allies, then the investigator may utilize the association of the ally and the profiler to gain an introduction 186 to the profiler by first contacting the ally. Any means used to introduce the investigator to the profiler through the ally is contemplated herein. For example, the ally could contact the profiler on behalf of the investigator, or the ally could arrange an online meeting in a chat room of the two, or the ally could serve as a liaison between the two until a more comfortable level is reached. Most likely, the ally will relay information between the investigator and the profiler until they are comfortable directly contacting each other, or arrange an introduction of the two. This type of arrangement is beneficial to all parties involved because it introduces in an online setting an element common to real space—that of using relatives, friends, acquaintances, etc. to come in contact with other individuals, professionals, and/or entities of interest.

Although impossible to recite each, some of the types of communities in which the present invention technology may be implemented include online dating services, professional service industries, such as the health care industry or the legal profession, and others in which individuals are seeking information, histories, reputations, or any other type of information about another individual or entity.

As the present invention lends itself particularly to online dating and similar services, the following detailed description and accompanying drawings will focus on the user-to-user ally association technology of the present invention as designed to be implemented within this arena. This example sets forth only one exemplary embodiment of the technology of the present invention, albeit the preferred embodiment, and is not meant to be limiting in any way, as will be recognized by one skilled in the art. Other systems and features are presented that are designed to work in conjunction with the present invention ally association technology and will be apparent from the disclosure provided for herein.

### Exemplary Online Dating Service

As stated above, online dating services have become extremely popular and attractive to their users in the past several years and provide great opportunities for people to meet and interact with one another, yet are limited in their functionality in that they have been unable to recreate many of the benefits and advantages of using third-party resources to meet, interact, and establish relationships with one another.

Utilizing such third-party resources, such as friends and acquaintances or other various associations, to meet or to come in contact with others whom it is desirable to establish and forge a relationship with, not only in the dating arena but in any other arena as well, is a valuable resource and can produce greater results and provide greater benefits than doing so with no previous contact or with nothing in common. This is true for several reasons. First, it is simply easier to have a mutual friend or acquaintance introduce two parties than to approach someone or seek someone out with nothing more. This is often referred to as an “in” and is used everyday to help introduce people or entities hoping to form relationships with one another and to bolster and foster such relationships.

Second, first impressions are improved as the initial meeting seems to start out on a higher, more comfortable level. Having a mutual friend or acquaintance instantly provides an element of common ground between each party that can quickly help to remove any uncertainties or uneasiness that may be felt or experienced. In addition, one is likely to have greater feelings of trust and acceptance if the friend or mutual acquaintance introducing the two parties is trusted or has supplied information to one or both parties prior to their introduction.

Third, there is a greater sense of trust and credibility established with each party involved. Meeting someone new or making an effort to establish or strengthen an existing relationship can be difficult and straining for both parties involved. Without a mutual friend or acquaintance, each party is required to trust that what the other is telling them is true. This can be very strenuous and even disappointing at times. There is always a greater level of comfort and trust if there is initially some common ground between the parties involved. Having a mutual friend or acquaintance instills this greater level of trust in each party that would otherwise not be present, or at least would not be present as quickly. This initial greater level of trust does several things, such as removing many doubts and uncertainties, as well as providing a spring board for each party to begin building their own relationship of trust with each other. This is especially true if there is a high level of trust between each party and the mutual friend or acquaintance. In addition, the parties can learn a lot about each other through the third-party friend or acquaintance prior to even meeting or speaking to each other. If one party knows that the other party has been provided some insight and information about them, there is a greater chance they will be more honest and forthright with each other and it is also likely that they will trust that what the other is saying is true. At the same time, if one of the parties is unaware that a friend or acquaintance has informed the other party about him/her, then the informed party can be much more critical of what they are told and will have a greater chance of knowing whether what is said is true or not. Moreover, relationships that begin with a greater level of trust are healthier and much stronger than those where there is little or no trust.

Fourth, having a mutual friend or acquaintance makes resolving concerns and making commitments easier. While this element or advantage is not necessarily directly resultant from the mutual friend or acquaintance, this is a natural result due to the greater level of trust and comfort instilled in each person from the beginning. Having a mutual friend or acquaintance will often serve to unite two parties due to the fact that they know and trust their friends and naturally desire to see them happy. Thus, if the mutual friend or acquaintance is excited about the relationship, then the parties involved are also more likely to be excited about their relationship.

Fifth, a ring of friendship is established that was not otherwise in existence. Many times we become friends and even closest with friends that have been introduced to us. While we may not even recognize what is happening, there soon becomes a circle of friendship between several people that did not exist and would not exist were it not for the introduction of two parties through a mutual acquaintance. This cycle is very capable of perpetuating to the point where several friendship rings may be developed. These rings of friendships fall under the penumbra of “communities” discussed above and are created from the associations of each party involved.

These advantages are not meant to be limiting in any way. Indeed, other advantages may be recognized by and will be apparent to one of ordinary skill in the art. In addition, these principles, as well as others, may be equally applicable to the various other communities intended to be formed or established and strengthened by the present invention. For example, in the legal profession, lawyers or their clients may utilize the present invention to provide referrals and information about a particular lawyer to others, including other lawyers. Similarly, in the health profession, various health care providers, such as doctors, may utilize the present invention to refer other health care providers to others interested. However, as stated, the ally association technology of the present invention lends itself particularly well to online dating services. Therefore, a detailed description of one such service is provided herein with an emphasis on the ally association technology as applicable.

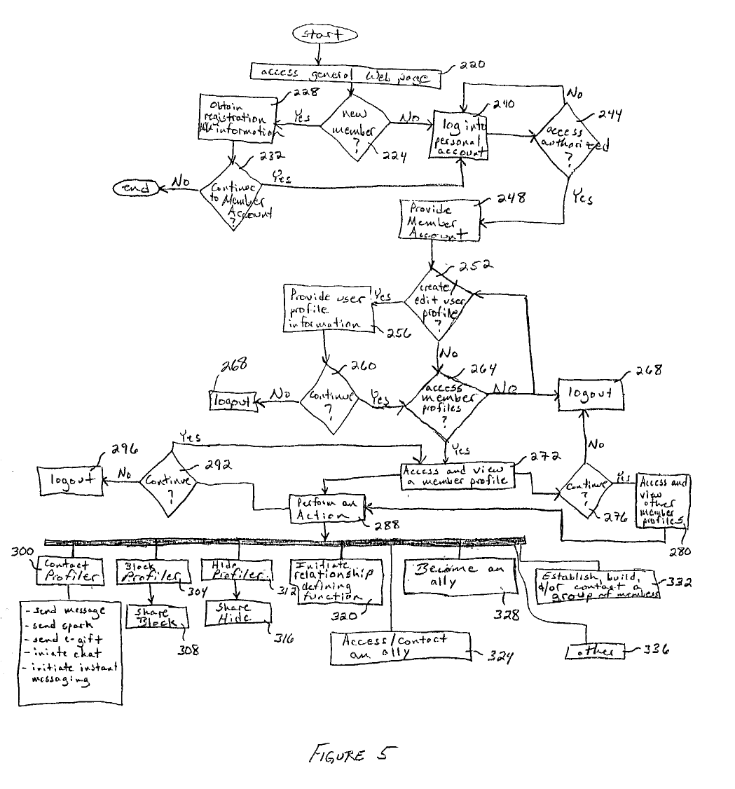

With reference to FIG. 5, shown is a flow diagram of an online dating system implementing the user-to-user ally association technology of the present invention, along with other inventive concepts as provided for and discussed herein. Specifically, the present invention features a community of computer network-based users, such as users on the Internet. Initially, an investigator accesses a Web site or a Web page 220 comprising either a home page of a particular service requiring the investigator to login to the service's system, or the Web page may comprise a main user profile, in which case the user is granted direct access to the feature profile. In this embodiment, the investigator is required to log into the dating service system. Once the feature profile is accessed 220, it is determined whether the investigator is a new or an existing member 224. If the investigator is a new member, and if the investigator wishes to join the system, the necessary registration information is obtained 228. Once this registration information is obtained 228, the investigator may continue to his/her personal member account 232 where he/she will be required to log in 240, or the investigator may opt to end the session without logging into the system and return at a later time. If the investigator is an existing member, the investigator is directed to log into the system by logging into his/her personal account 240. If the investigator's login information is authorized 244, access to the system and his/her personal profile is granted or provided 248. From here, the investigator may create 252 a personal profile if he/she is a new member or edit 252 his/her personal profile if he/she is an existing member. For purposes of discussion, a member is a general term describing a person that has subscribed to the online dating service and that has created a personal profile. A personal profile, or simply profile, is one or several Web pages describing the personal details, characteristics, attributes, etc. of the featured member owner.

If changes to the investigator's (or member's) personal profile are desired, the investigator is directed to provide the information 256 to be uploaded and stored on the system that is specific to that particular investigator. Profile information may contain any type of information, such as name, age, place of birth, residence, hair color, race, religion, height, weight, occupation, interests, hobbies, dislikes, personal essays, photographs, etc. Member profiles and the information contained thereon are, for the most part, similar to those known in the art and comprise much of the same information as prior art dating service member profiles. However, significant differences are apparent, which will be discussed below.

Once this information is added or updated, the investigator is allowed to continue 260 by either logging out of the system 268 or determining 264 to continue on by accessing 272 his/her own profile or other member profiles. Other member profiles accessed will most likely be those of particular interest to the member. In the event that no changes to the member profile are required or desired at this time, the investigator may likewise either log out 268 of the system, or continue on 260 within the system by accessing 272 other member profiles.

Accessing a member profile typically involves viewing the profile. As mentioned, once a profile is accessed, it may be termed a feature profile and the featured member or owner a profiler. However, the present invention system allows certain actions to be performed from each feature profile, depending upon whether the feature profile is the investigator's profile or a another member's profile. These actions include contacting 300 the profiler by sending a message, an email, an e-gift, and/or initiating chat or instant messaging, blocking 304 one or more profilers, sharing 308 this block with other users, hiding 312 the profiler and sharing 316 this hide with other members, initiating 320 a relationship stage defining function with another member 320, accessing or contacting 324 one or more allies posted thereon, becoming 328 an ally, establishing, building, and/or contacting 332 a group of members having a common interest, or any other action 336 obvious to one ordinarily skilled in the art. Each of these actions is described in greater detail herein.

Once all desirable actions have been undertaken and one or more various member profiles have been accessed, the investigator or member may continue on 276 by accessing 280 other member profiles in a similar manner with similar actions undertaken for each, provided these members are utilizing one or more of the user-to-user ally association functions of the present invention. Alternatively, the investigator may simply end the session and log out 268 of the system altogether.

Ally Association Function

The present invention features a user-to-user ally association software module, wherein the users within a community are selectively associated with one another by serving as allies to each person or entity desiring to have them as such. Each ally is capable of many roles, among which are to witness for, identify, validate, make reputable, serve as contacts for, etc. each person or entity for whom they are acting as an ally. Through these ally associations, a much more effective way to meet and interact with other users within the community is provided, along with the resultant effect of creating and developing a greater sense of “community.”

In short, the ally association function or system helps users within a community to meet and interact in a more effective and efficient manner. At the same time, it provides a more safe and trustworthy environment. In the context of online dating, the ally association system helps singles looking to meet and form relationships with other singles meet each other more easily. An ally may be referred to or described as a user, member, investigator, or profiler that is associated with and is a witness for at least one other user, member, investigator, or profiler.

As described above, once the personal user profile of a member of the online dating service is created, including information relating to the member, this member can take on the role of an investigator and search the database or directory for the purpose of locating other member(s) that are either relatives, friends, or acquaintances of the investigator. Once located, the investigator may access and view the feature profile of any or all of these. Upon doing so, the investigator can request to become an ally of the profiler. To become an ally, the investigator first contacts the profiler by sending a request asking to be an ally for the profiler. If a positive response is received or returned, the investigator is approved to become an ally for that particular profiler. At this time an ally profile is added to the featured profile or user profile of the profiler. The ally profile preferably comprises various items and information including, but not limited to, a photograph of the ally, various information about the ally, information about the profiler as supplied by the ally, one or more links that will take investigators directly to the featured profile of the ally and/or those that are allies of the present ally. By way of example, if A visits B's main profile page and discovers that A has a prior relationship with B, A can request to become an ally to B. If B approves of the relationship and allows A to become an ally, an ally profile A is added to B's user profile. A's ally profile may include a picture of A, a link directly to A's user profile, comments about either A or B, a description of B as provided by A, and/or pictures and/or links to C and D, who are allies to A. In this example, B is a first degree ally to A, and C and D are second degree ally to A but first degree ally to B. This concept is discussed in greater detail below. Essentially, each time A's profile is accessed and viewed, B,C, and D will appear as ally to A, along with whatever information has been supplied by each of these.

Preferably, each investigator, prior to becoming an ally, is prompted to describe the profiler, to provide comments about the profiler, as well as to ascribe different characteristics and attributes to the profiler that will be posted on the profiler's user or feature profile. This will allow other investigators accessing and viewing the profiler's feature profile to see what the allies think of the profiler and how the profiler is perceived, and to exercise available options to meet the profiler through contact with one of the allies. Typically, this information will be posted within an ally profile corresponding to each respective ally providing such information.

As stated earlier, each member within the online dating community is required to create a user profile. Here, they can describe their personal likes, dislikes, interests, hobbies, personality, traits, characteristics, favorite places and things, and any other useful information. At the same time, each ally is able to unilaterally supply similar information about each profiler they are associated with. As such, one of the unique features of the present invention user-to-user ally association technology that is not found in prior art systems is the establishment of the attributes, characteristics, and any other inflation proposed and set forth for display by each member through the witnessing of such by one or more allies. Stated differently, the ally association function of the present invention provides each investigator the ability to view and receive information pertaining to the attributes, characteristics, etc. of any member as provided not only by the member themselves, but also by one or more allies. In essence, each ally serves to verify that the information provided by each member in their member profile is accurate. Verification is achieved by allowing each ally to provide their own information about the member, as well as to rate the member based on similar criteria used to initially establish and create each member profile.

In one exemplary embodiment in the online dating arena, providing and entering personal information facilitates the creation of a member profile. After a member profile is created, the member can invite friends from the community to become allies for the member. This means that the member profile will preferably display one or more allies thereon within an ally profile, respectively. This is beneficial to the member as they have one or more allies that can vouch for them and assure others that the member has described themselves accurately and is who they say they are. In addition, the allies can rate the member in the form of color coded identifiers. For example, color coded personality halos could be used to indicate various attributes and/or characteristics of that member, wherein red equals hot, orange equals medium, and yellow equals mild. Thus, if an ally is rating a member's sense of humor, red could mean funny and a jokester, orange could mean funny, but not an initiator, and yellow could mean grumpy. The information asked to be provided by each ally is similar. Thus, the opinions of the allies help other investigators accessing and viewing the feature profile of a particular member to get a better idea of the attributes and characteristics of the member profiler. In addition, the opinions of the allies serve to vouch that what the profiler has posted is truthful and that they have accurately described themselves. Conversely, if there are significant discrepancies in opinions between the profiler and the allies, investigators will be warned from the outset. The principle that two or more witnesses help establish a truth is a primary operating principle of the ally association technology of the present invention. A quick glance at the posted information provided by the profiler in comparison with the same information provided by each ally may be very helpful in discerning the real attributes and characteristics of the profiler. For example, if the profiler says they are “red” for outgoing but their allies say “yellow,” then the person reading the main profile of that person will recognize some discrepancy between the profiler's assessment of themselves and what others perceive. As such, the more allies a profiler has the better as the law of averages from the combined efforts of the allies will lead to a more accurate assessment of the profiler.

Upon the completion and establishment of one or more allies, a system of contacting means is put into place whereby either the profiler or their allies may be contacted. Email is a good example of a way an ally or profiler may be contacted. Emails may even be received regardless of whether the member or ally is being contacted directly or if another investigator shows interest in one or the other. This system provides and introduces a much more efficient and effective way for members within the community to meet, interact, and establish relationships with each other.

There are various scenarios under which a profiler or an ally may be contacted. First, another member of the community, an investigator, thinks the profiler is interesting. Contact with a profiler may be direct or indirect. Direct contact is well known in the art and involves an interested investigator accessing another member's feature profile and taking the appropriate steps to contact that profiler directly, such as through email, instant messaging, or whatever other systems are in place. Indirect contact is something new to the online community and is discussed below.

Second, another member, an investigator, of the community thinks one of the first degree allies is interesting. If interested, the investigator is preferably able to be directed or taken to the feature profile page of the ally of interest via clicking on a link or typing in an address as listed on the profiler's feature profile.

Third, an investigator thinks one of the second degree allies is interesting. This is a similar scenario as the previous one.

Fourth, an investigator thinks the profiler is interesting and contacts one of the allies to gather more information about the profiler. In this scenario, the investigator is seeking to contact the profiler through an association with one of the allies. This indirect contact is unique to the present invention and within an online setting. Indirect contact occurs often in real space, and involves a third-party individual or entity serving as the contact, liaison, intermediary, matchmaker, or referring party between two or more individuals or entities. For example, in dating, a “set-up” is extremely common and may be defined as a date between two individuals who were introduced to each other and lined up through a third-party acquaintance. Indirect contact, among other things, is extremely effective and helps to ease the initial meeting of two individuals. The present invention seeks to bring such effectiveness and efficiency to various online communities around the world.

Fifth, an investigator thinks one of the allies is interesting and contacts the profiler for more information on that particular ally.

Sixth, a second degree (or beyond) ally thinks the profiler is interesting.

In essence, since the profiler and the ally are connected or associated with each other by a matter of degree, many opportunities exist to establish groups, to introduce one another, and to help each other meet those members of particular interest. It should be emphasized that each ally serves as a resource for investigators in the community. For instance, an ally may be a resource for investigators seeking to establish a relationship with the profiler hosting the ally, or an ally may be a resource for the profiler in attracting others to their user profile, or an ally may be a resource for other allies. The relationships and contact possibilities are numerous, particularly as the ally association system proliferates throughout the community. Indeed, one of the primary functions of the present invention ally association, or ally, system is its ability to proliferate throughout the community so that eventually each member is associated with at least one other member to the point that the online community comprises the same or similar types of groups, associations, contacts, relationships, and resources as found in real space. As such, it is intended that each member within the community have at least one, and preferably a plurality of, allies existing on their member profile, and that each member within the community be an ally, of any degree, to at least one other member. If no ally associations are present, the present invention functions much like prior art systems.

In the context of an online dating system according to one exemplary embodiment of the present invention, a single member, an investigator, of the Internet dating system. and community can request to be an ally for another member of the site. Upon request, the investigator completes and submits an information form relating to the profiler. The information form may comprise any type of information, but typically will include a description of the profiler and/or a rating of the various characteristics and attributes of the profiler, such as their personality, enthusiasm, sense of humor, etc. Rating such characteristics and attributes will involve assigning or ascribing an identifier for each of these. In addition, each attribute or characteristic may be assigned a number or a color indicating their level of qualification for that particular trait. In the embodiment presented herein, for example, the profiler's personality may be assigned either a red, orange, or yellow mark corresponding to funny, spirited, or serious, respectively. A similar rating may be done for each attribute or characteristic. In addition the investigator may preferably write a short sentence that gives a personal opinion about the personality of the profiler. When complete, this information is forwarded on to the profiler for approval. The information may be accepted, denied, or sent back to the investigator for modification. Once the request to become an ally is approved, the investigator becomes or is established as an active ally for the profiler and an ally profile is added to the profiler's member or feature profile (to be included with other allies), along with a link to the member page of the ally and any information approved for posting, such as any ratings or descriptions as discussed above.

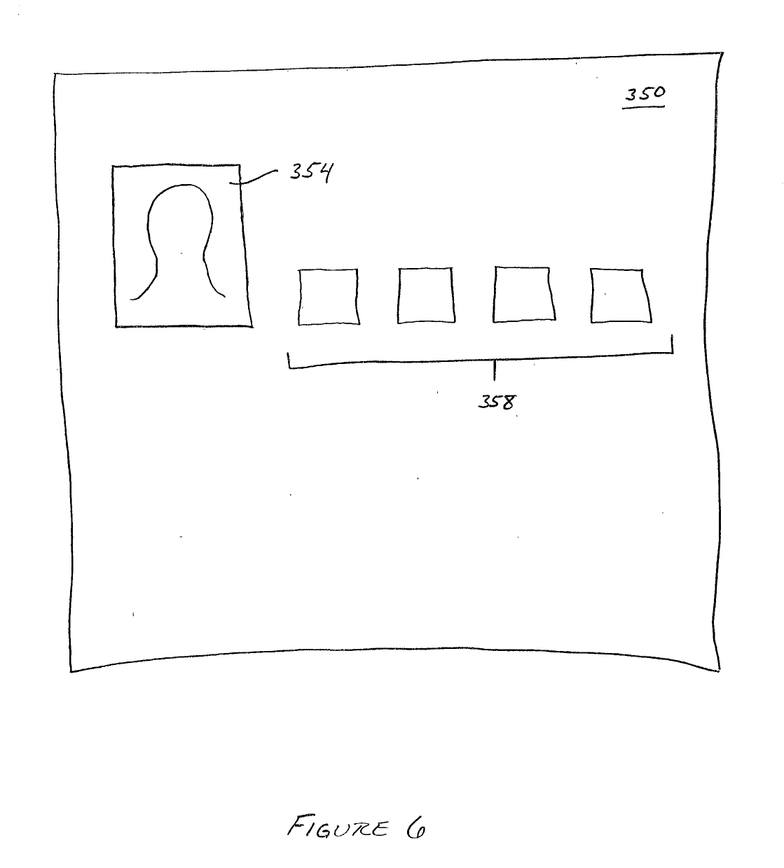

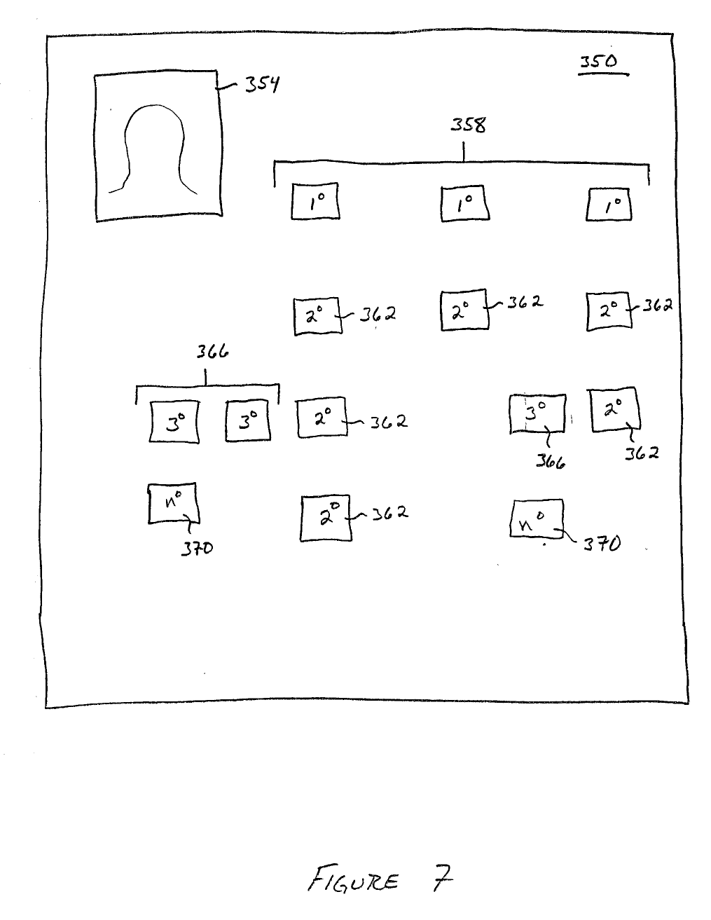

With reference to FIGS. 6 and 7, shown are the possible degrees of association between the profiler and their allies. The ally association technology of the present invention is not restricted to any limitation regarding the number or the degree of allies displayable and operational within a member's profile, or that a member is capable of having. Indeed, the technology of the present invention functions optimally when there are multiple degrees of allies on each member's profile to provide multiple connections of people who know each other, as well as who do not know each other. FIG. 6 illustrates a feature profile 350 of a profiler 354 having a plurality of first degree allies 358 posted thereon. First degree allies are those that have specifically requested to be allies of the profiler and have gone through the request/approval process described above. FIG. 7 illustrates a feature profile 350 of a profiler 354 having a plurality of first degree allies 358, a plurality of second degree allies 362, a plurality of third degree allies 366, and a plurality of nth degree allies 370 posted thereon. Second degree allies 362, while second in degree to the profiler, are first degree allies to the profiler's first degree allies 358. Likewise, third degree allies 366, while third degree to the profiler, are first degree allies to the profiler's second degree allies 362. This hierarchy or genealogy of allies may branch as often and as deep as necessary to the nth degree as shown by nth degree ally 370. As such, a feature profile may comprise any number of allies to any degree.

In real space dating, people often “set-up” their friends on “blind-dates.” Indeed, most online dating sites are built with the purpose of a one on one relationship between a profiler and an interested member. In contradistinction, the ally association technology of the present invention provides for a dynamic system that allows members to meet and interact with each other in a way similar to real space.

The ally association technology of the present invention seeks to recreate, in an online environment, many of the advantages and benefits existing in real space dating. However, while somewhat similar to real space dating, the present invention technology provides a much more effective system in action. Each member in the online dating community, upon associating with and establishing one or more allies, is able to rely on these allies to vouch for them and to set them up with other members and visitors to the Web site. Thus, unlike prior art dating systems or services, the present invention will allow each member to associate themselves with other members for the purpose of vouching for and referring each other according to the relationships established and built as a result of the contact and interaction amongst and with the allies. The ally association technology creates and fosters a common goal amongst all members of the community—to meet and develop a relationship with the profiler of interest. Through the technology of the present invention, the chances of accomplishing this goal are greatly increased for all members.

Another significant advantage of the ally association technology as implemented in an online dating service is its ability to naturally allow people to meet each other for purposes other than to become romantically involved. Acquaintances, friends, and simple referral and vouching relationships may be established, and may fall under the penumbra of a “relationship.” Indeed, there may be times when a member or user is not necessarily a close friend of a profiler but has dealt with that member in the past, such as in a business deal or similar venture, and is willing to vouch for the member to other members or users showing interest. The ally association technology allows the barriers between the profiler and other interested members to be dropped, with each ally, regardless of degree, being able to concentrate on providing means for the profiler and the investigator to meet and build or establish a relationship.

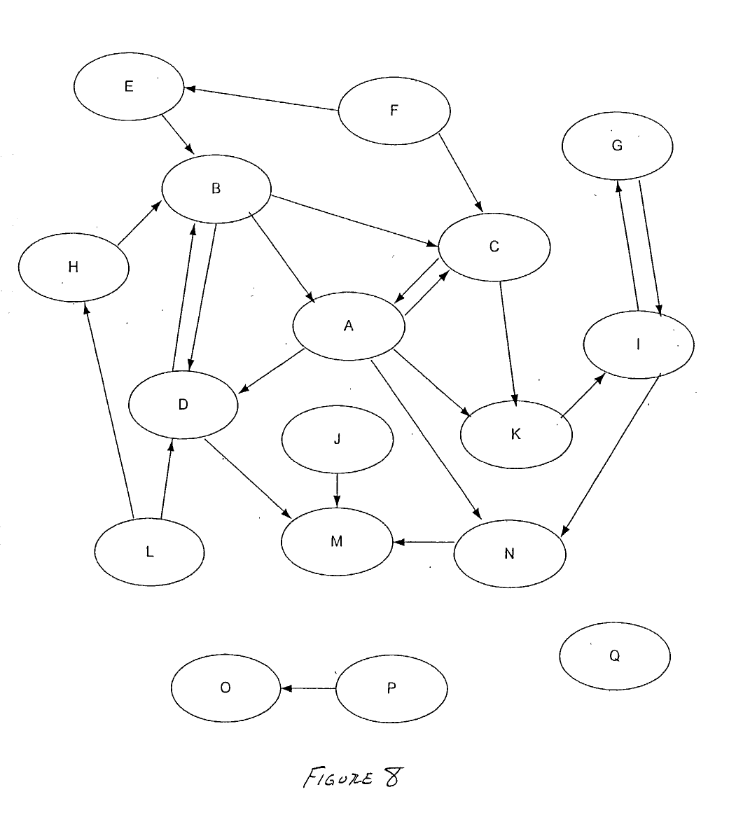

The ally association system further allows multiple allies to interact with each other while working toward the goal of vouching for, referring, or otherwise “setting-up” each other with a profiler of interest. In essence, the present invention fosters and encourages a team effort with each ally being capable of meeting new profilers, as well as their allies. It can be said that the ally association technology transforms an otherwise passive community into a very active, viral, and connected community as shown in FIG. 8, wherein the users or members within a community are interconnected with each other through their associations, namely groups and allies. In a preferred embodiment, each member within the community will be provided an incentive to utilize the ally association technology of the present invention, such as by being rewarded points or credits redeemable for certain items, prizes, or membership-related rewards.

In light of the multiplicity of possible interactions available through the present invention ally association technology, there are several ways members within the community can locate, contact, and interact with each other. While not intended to be limiting in any way, some of the more preferable ways of communication or interaction and contact scenarios are investigator to profiler, profiler to investigator, investigator to ally, ally to investigator, profiler to ally, and ally to profiler.

An investigator to profiler relationship is well known and practiced in traditional online dating services. These relationships are made possible, but are not the primary focus herein.

Unique to the present invention is the ability to provide investigator to ally and investigator to ally to profiler contacts and relationships. An investigator can contact or interact with an ally of a profiler for the purpose of either getting to know the ally for themselves or for the purpose of getting to know the profiler, in which case the ally serves as an intermediary, contact, reference, or voucher for the investigator. In the latter scenario, the profiler may interact with the ally for the purpose of obtaining information about the investigator, or the ally can provide information about the investigator to the profiler, or direct the profiler to the feature profile of the investigator, or arrange an introduction of the investigator and the profiler. These are only one of many actions that may be taken and should not be considered limiting in any way.

In an ally to ally scenario, one ally can contact and interact with another ally in a variety of ways. For example, first degree allies can communicate with other first degree allies within their own group of allies or with other allies within other main profiles. Also, first degree allies can communicate with second degree allies within their own feature profile, or with other allies of other feature profiles. In addition, first degree, second degree, third degree and beyond can communicate with each other as provided herein.

Another feature of the present invention not found in prior art systems is the ability to search and display the members within a community and their allies. The ally association technology presented herein allows member profiles to be searched, with the results of the search not only returning information about the profiler but coupling the results with information and data pertaining to the allies associated with the profiler. In an exemplary embodiment, the home page of the online dating service preferably comprises a slide show feature where several select portions of member profiles are provided in a quick search frame. Investigators investigating the Site can pick whether to search males or females, and can browse the profiles featured in the slide show by advancing from one profile to the next. While this is known in the art, the present invention allows the allies of each profile to also be displayed, wherein the feature profile of either the profiler or the profiler's allies may be accessed via a link. Other searching features may be part of the online dating service that also provide information about both profilers and their allies.

Group Association Function

The present invention further features a group enabling software module or group system, wherein two or more members interact with one another to form and associate with one another in groups. Typically the group will be based on some type of association or common interest. However, a group may have any basis, including either similar or dissimilar interests. The group function is designed to bring members together to increase the social nature of the relationships formed and to bring closer together the community of members. Inherent in the establishment of a group is a group host that serves to create the group and/or coordinate various activities, meetings, etc. for the members of the group, either online or in real space. By virtue of the present invention group function, online group dating is made possible.

Groups are typically made up of profilers and allies. A profiler can create a group by inviting other profilers and allies to join the group. Typically, groups will be formed of members or allies having similar interests. For example, a group may be formed based on a particular hobby, sport, or other event. The group may also be based on specialized criteria, such as age, nationality, weight, height, social standing, income level, etc. The present invention is not limiting to any one criteria.

The present invention also contemplates group to group associations, wherein groups of allies or members can meet with other groups of allies or members.

In one exemplary embodiment, the group function is operated in the following way. Under an email option, the host of the group emails all of his/her first and second degree allies with an invitation to a group function. The invitation may suggest an online or offline place to meet. The group host establishes the date and time of the group function and notifies each member within the group. The group host may request that each member of the group RSVP, whereupon confirmations may be automatically sent out to each group member to remind them of the date, time, and location of the group function. One of the locations that a group may meet is in a group room. This helps to keep the function private and exclusive to the group.

Under a picture pulling option, the group host invites each of his/her allies by clicking on their pictures under a group function protocol. These allies may in turn invite their own allies by the same method. The invitation will mention the location, times, dates, and other pertinent information related to the group function. An RSVP may also be requested, upon which confirmations may automatically be sent.

Under a search engine option, any member within the community may join and be part of a group on their own volition. This option is provided through one or more pre-established groups available for anyone to join. Thus, a member wishing to get involved in a group may do so by choosing to join one or more groups from a list of groups provided by the online dating service. Once joined, each member of the group will be notified of various group functions and events as described above. A person may join any number of groups. In addition, any member may create a group and serve as a group host.

Plan of Friendship Relationship Stage Defining Function

The present invention further features a relationship stage defining function, such as the Plan of Friendship^{SM} relationship stage defining function provided by CoolSaints.com, L.C. of Orem, Utah. This feature allows two members to be able to define the present state of their relationship and know exactly what stage they are in without having to verbally discuss the issue. In addition, this feature allows one member to notify the other through on online notification object that they would like to take the relationship to the next level. If the other member is in agreement, a reciprocal notification is sent indicating the same. If the other member disagrees, either nothing is sent in return, or a lower stage notifier is sent. Essentially, this feature allows two members in a relationship to avoid verbally having “the talk.” Instead, each is able to discreetly indicate their intentions in the relationship.

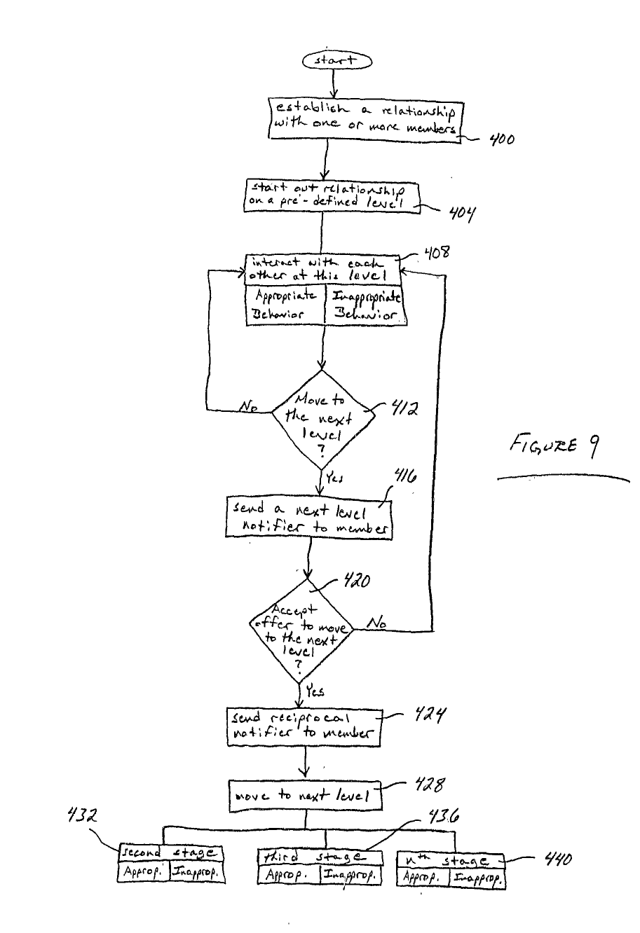

FIG. 9 illustrates one exemplary embodiment of the relationship defining function of the present invention. Specifically, FIG. 9 illustrates a flow diagram showing that a relationship is to be established 400 between two members. Each relationship preferably starts out on an initial pre-defined level 404 appropriate for an early online relationship. This level is defined by the operators of the online dating service and is known to all participating members. It is at this beginning level that the members in the relationship initially interact 408 with each other. In addition to defining the levels or stages of a relationship, each level has defined therein both appropriate and inappropriate behavior. These are discussed below. As a relationship continues on, it will be determined at some point whether to advance the relationship and move to the next level 412 or continue on at the same level. If one member feels that they would like to advance the relationship, the present invention stage defining function allows them to send 416 a next level notifier to the other party involved, which is a notification indicating that the sending member would like to move to the next pre-defined level or stage in the relationship. Indeed, each of the levels in the online dating community are preferably defined so there is no confusion or mistake between members. A next level notifier can be anything that one member sends to the other indicating that they wish to move to the next pre-defined level, such as a canned email or an instant message, etc. At this time, the receiving party can choose whether or not to accept 420 the offer and move to the next stage or level in the relationship or stay at the present stage. If the receiving party agrees to the advance in the relationship, this is indicated to the sending party by sending 424 a reciprocal next level notifier of the same type. Upon receipt of the reciprocating next level notifier, the relationship is advanced 428 to the next successive stage. This process continues for each stage pre-defined in the online dating system. In addition, the relationship may digress by the reverse of the process just described, or may end abruptly at the sole discretion of one or both of the members.

FIG. 9 also illustrates the several pre-defined stages of an online relationship that members may fall within, along with the pre-defined behavior considered either appropriate or inappropriate for each stage. Specifically, each stage represents a definition of what is appropriate and inappropriate when getting involved in a relationship online. As stated, everyone in the system preferably starts out on the first stage until it is indicated otherwise by one of the involved parties and agreed upon by the other. Each successive stage may be moved through at a pace dictated by the combined or mutual agreement of both parties.

In one exemplary embodiment, these stages may be defined as follows:

Stage One 404—The Introduction period designed for each person to get to know one another. In this first stage, appropriate behavior may be defined as communication on a level of acquaintance only, and sending a notification to move to the second stage. Inappropriate behavior may include any action that does not fall under the relationship of acquaintance, such as sending intimate information or having intimate conversations that one party does not feel comfortable sharing, and/or sentiments of love, such as love letters, poems, or anything not appropriate for newly formed friendships.

Stage Two 432—The Mutual Interest period designed to help each person build a lasting relationship. In the second stage, appropriate behavior may include communicating on a more personal level, sending a notification to advance to the third stage, etc. Inappropriate behavior may include any action that does not fall under a second stage relationship as defined as well as intimate inflation or intimate conversations that one person does not feel comfortable sharing, etc.

Stage Three 436—The Advanced Relationship stage is designed for those that are mutually interested in communicating outside of the confines of the online dating community. During stage three, appropriate behavior may be defined as sharing personal information that each person feels comfortable sharing, communicating on a level greater than just acquaintances but not yet on the level of good friends, sending electronic flowers and electronic gifts, sending “Thinking of you” notes, and/or exchanging personal information if comfortable. Inappropriate behavior may include any action that does not fall under the relationship as defined in the third stage, intimate information or intimate conversations one person does not feel comfortable sharing, love sentiments including love letters, poems, egifts, or anything not appropriate for newly formed friendships. Some of the electronic gifts, or egifts, may include electronic flowers, electronic candy, electronic presents (Christmas, Birthday, Valentines Day, or any other special occasion), and “Thinking of you” notes.

Other stages 440 may also be defined and provided for in the system.

Shared Block Security Function

The present invention further features a security and group blocking function, such as the Shared Block^{SM} security and group blocking function provided by CoolSaints.com, L.C. of Orem, Utah. A group blocking function is a computer program module that functions to allow any user within the computer network community of users to unilaterally and selectively initiate a block directed to or targeted at one or more other users within the community and to allow that user to share the block with other users. This technology functions as a result of or is directly related to the user-to-user ally association technology of the present invention. The group blocking function is essentially a prohibition preventing the targeted user from viewing, accessing, or obtaining information about, or contacting or sending anything to, the user initiating the block. In essence, any user within the community has the ability to unilaterally and selectively cut off any other user's ability to view or access information about, contact, or otherwise interact with the user initiating the block. For example, B views the inflation about or contacts A and immediately or over the course of time does something to upset A or cause A to become worried or nervous. In this case, A can initiate a block of B that prevents B from ever viewing information about or contacting A again until A removes the block. This provides A with protection and security against unwanted interaction or dissemination of information.

While initiating such blocks are common and known in the art, the present invention builds upon this technology by allowing these blocks to be shared amongst users within the community through the user-to-user ally association technology as presented and described herein. As such, the security and group blocking function operates or works in conjunction with the ally association technology to share the block with those associated with the blocking user. This group blocking function, while prohibiting the blocked user from accessing or viewing the blocking party's information, serves to simply put other users on notice of the block. Stated differently, the allies of the blocking party may be made privy to the block in that they receive what may be the equivalent of a warning indicating that a particular user has been blocked from accessing another particular user's information. In a preferred embodiment, only those individual users associated with the party initiating the block, or the initiating party's allies, will be notified in order to prevent unnecessary proliferation of the block. However, if appropriate, the block could be spread throughout the community and the blocking party banned from further contact with anyone in the community.

Although the system administrator has control over all parties in the community, each individual user has control only over his/her own information. In other words, a user is not allowed to block any other user's information, or a user may not prevent any other user from accessing or viewing any information but his/her own.

Once a block has been initiated, the party blocked has no access, viewing, or interactive rights to the initiating party's profile. Likewise, once a block has been initiated, the party blocked is prohibited from contacting, communicating, or otherwise interacting with the party initiating the block. As such, one must commit a rather serious transgression to justify being the target of a block. As mentioned, whether to initiate a block or not is at the sole and unilateral discretion of each user. However, although obvious, it should be stated that the system administrator reserves the right to block or remove any profile it wishes.

In the case of a user block, the decision is preferably governed or guided by a set of pre-established rules or criteria known to each user prior to their participation in the community. These rules are preferably made known to all users in the community and serve to put each user a notice that certain behavior, conduct, words, actions, and/or events are grounds for being blocked from a particular user's profile and information or contact with that user. As such, a block is typically initiated only upon the occurrence of one or more prohibited events as set forth and established by the rules. By way of example, and not intending to be limiting in any way, some of the types of acts that may be prohibited and that may give rise to a block of a user may be: 1) crude, suggestive, derogatory, or sexually explicit language; 2) repeatedly sending unwanted emails or other communications to the user; 3) making threats of any kind; 4) making unwanted sexual advances; 5) preying or stalking in any form; and/or 6) anything that the user feels is inappropriate and that he/she has warned against.

Just as the initiation of a block is preferably governed by a set of pre-established rules and criteria, and just as a block is preferably shared with others in the community, the sharing of this block is also preferably governed by similar pre-established or pre-identified criteria and rules. In one exemplary and preferred embodiment, the rules may establish that notification of a block will proliferate within the community only to those parties associated with the user that initiated the block. Referring back to the example, if A blocks B, only those users who are allies to A will receive a notification that B has been blocked. However, the rules may establish that notification of the block will proliferate to allies of a greater degree or even all users. Any rule of dissemination is contemplated herein. In addition, the system may be set up so that notification occurs automatically or upon the unilateral action of the blocking party, wherein the blocking party can selectively send notification to one or more users, whether these are allies or not. Still further, the rules may establish that those allies of A may only receive such notification upon B accessing their own information. As the notification is intended only as a warning, those allies to A, as well as any other users within the community that are in receipt of the notification, are free to communicate and interact with B as they deem appropriate, although such interaction will most likely take place with greater caution and at a heightened state of awareness.

The main reason for blocking another member is to create a safety net between members. Utilizing the group blocking function where appropriate serves to preserve the security and safety of the community. By initiating the group blocking function where appropriate, ill-intentioned members are showcased to other members. In this way, better control of the community is made possible by warning those that intend to cause trouble and make others feel uncomfortable that their actions will be known by many, if not all, members and their viewing privileges restricted or revoked.

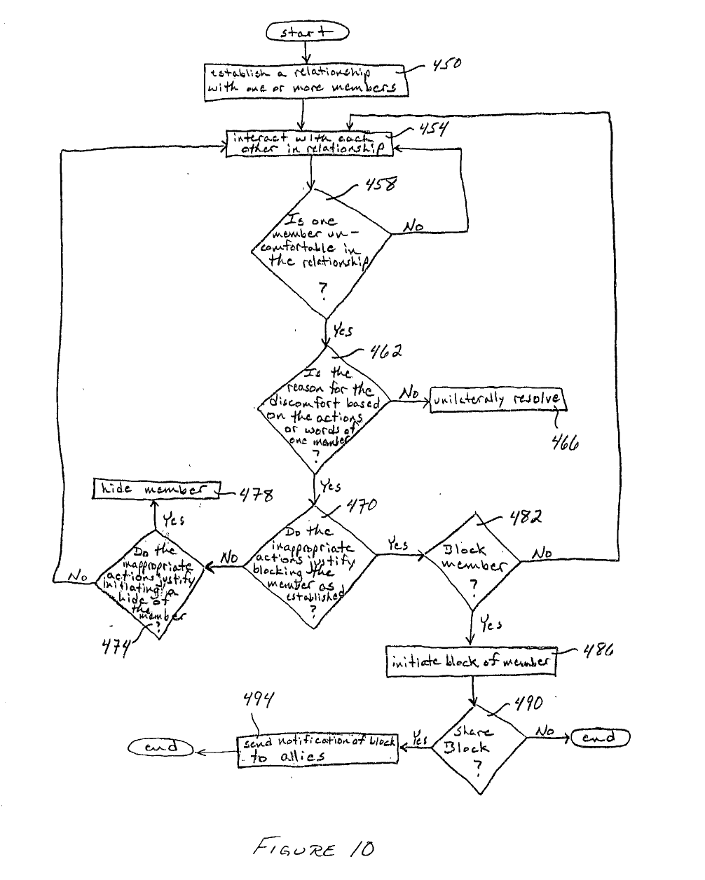

In one exemplary embodiment, as shown in FIG. 10, illustrated is a flow diagram of the security and group blocking function. Specifically, a relationship between two or more members must be established 450. Once established 450, the members interact 454 with each other in the relationship. Often times, relationships do not work out as planned and one member may feel uncomfortable with either the actions, words or gestures of the other. In this case, the present invention provides the ability for a member involved in an online relationship to determine 458 whether he/she is comfortable in the relationship or not. If so, the relationship may continue on as normal. However, if one of the members is uncomfortable and this is determined 458, it should next be determined 462 if the reason for the discomfort is based upon the actions, words, or gestures of the other member. If not, the problem may not be too serious and the parties can resolve 466 it themselves or one party may do so unilaterally, if appropriate. On the other hand, if it is determined 462 that the reason for one member's discomfort is based upon the bad actions, words, or anything else of the other member, then it must be determined 470 if these actions are at a level to justify initiating a block of the member. Preferably, each member will be provided guidance and instructions on the types of behavior that justify initiating a block of another member so that this feature is not abused or that blocks are not subjectively instigated or applied. If, under the defined set of criteria and rules, the behavior of the member does not justify initiating a block, then it should be determined 474 if the behavior justifies initiating a hide of the member. If so, the member can discontinue the relationship and hide 478 their profile from the misbehaving member. If not, the relationship may continue. Also, any behavior not meeting acceptable standards can be reported to the administration for further action, if necessary.

If it is determined 470 that the behavior of one member justifies the initiation of a block on that member, the member contemplating such must decide 482 whether or not to actually initiate the block or not. This determination may be made unilaterally with the help of guidelines provided beforehand. If such a block is justified and determined to be appropriate, the member can indeed terminate the relationship and initiate a block 486 of the misbehaving member. A block is different than a hide in that a block completely locks out and specifically prohibits the blocked member from accessing or viewing the blocking members profile, or from contacting the same.

In addition, due to the ally association technology of the present invention, the member initiating the block can decide 490 whether or not to share the block with other members in the community so others may be put on notice of the block and warned about that particular member. This decision is simply a matter of choice and can be done by sending 494 the block, or a notification of such, to the member's allies in any degree. For example, if member A is receiving emails from member B and those emails are making member A feel uncomfortable, then member A can block member B from ever viewing member A's profile. Member A can also initiate or send a group block function to A's allies. This group block can be sent from first degree allies to second degree allies and so on.

Traditional online dating services utilize a one dimensional block, wherein a user blocks another user from viewing his/her profile. However, the prior art does not provide a group blocking function as provided for herein. This is due to the fact that prior art systems do not comprise the user-to-user ally association technology as described and provided for herein to associate one user with another.

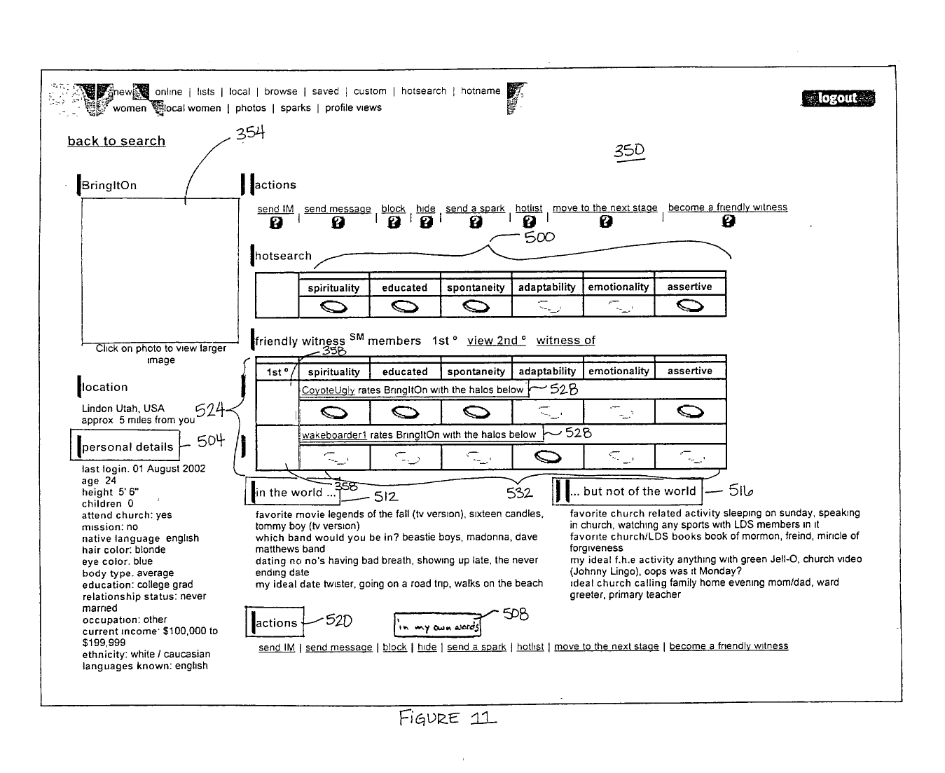

FIG. 11 illustrates one exemplary embodiment of the present invention as incorporated into an online dating service. Specifically, what is shown is a feature profile 350 having a picture of a profiler 354 featured thereon, personal information 504 about the profiler, a rating system 500 of identified characteristics that the profiler personally provided, a short personal statement or description 508 pertaining to and provided by the profiler, personal interests and likes 512 of a non-spiritual nature, and personal interests and likes 516 of a spiritual nature. Feature profile 350 also comprises a plurality of actions 520 an investigator accessing the site may select and carry out. The information and features provided herein are known in the art. However, the present invention feature profile further features one or more allies 358, shown as allies in the first degree. These allies are featured in an ally profile 524 and function as described and taught herein. Each ally profile, corresponding to a respective ally, preferably comprises information about the profiler. This information is in the form of a short statement 528 about the profiler provided by the ally, along with a rating system 532 rating the characteristics and attributes of the profiler, also as provided by the ally. It should be noted that rating system 532 and rating system 500 comprise the same attributes and characteristics so that any investigator may quickly compare the rating provided by the profiler to the rating provided by the allies of the profiler.

Safety Net Verification Function

The present invention further features an identity verification system or function, such as the SafetyNet^{SM} verification system or function provided by CoolSaints.com, L.C. of Orem, Utah. This system functions to ensure safe user-to-user community interactions by verifying the identity of each user or members within a community.

The verification function of the present invention is designed to verify the identity of each user or member through the gathering of an official copy of at least one form of legal identification, such as a driver's license, passport, birth certificate, and/or notarized document proving that the identifying information given is accurate.

Upon proper verification, a seal or stamp of approval may be posted on the feature profile of each profiler. If a seal is not posted, investigators are immediately put on notice that the profiler may not be who they say they are or may have false or fictitious information on their profile.

Safety Net Authentication Function

The present invention further features an authentication function, such as the SafetyNet^{SM} authentication function provided by CoolSaints.com, L.C. of Orem, Utah. The authentication function of the present invention functions as follows. Once one or more users or members have established a good online relationship and are ready to take another step forward by exchanging offline information about themselves, such as a real name, phone number, address, or any other information previously kept hidden, the present invention authentication function may be utilized as the vehicle to actually exchange and receive the information. This is preferably done by a third-party entity capable of performing such tasks. If the information a user or member receives from another user or member is not the same as the information received from the authentication function, a notification and warning is sent to the perspective recipient cautioning him/her that the information of the sending user or member does not match and that their information has not been properly authenticated.

The present invention may be embodied in other specific forms without departing from its spirit of essential characteristics. The described embodiments are to be considered in all respects only al illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A system for building a reference hierarchy within a computer network-based community, said system comprising:
a server system comprising one or more servers;
a plurality of user profiles supported on said server system and corresponding to a plurality of users, wherein said plurality of users may take on one of several roles, namely an investigator, a profiler, and an ally depending upon whether said users are accessing and viewing other users' profiles, said users' profiles are being accessed and viewed, and if said users are associated with other users, respectively;
an ally association function, wherein one of said users is selectively associated with another one of said users as an ally, said ally association function activated when an investigator initiates a request to become an ally associate of a profiler upon viewing a feature profile of said profiler, said profiler having the ability to choose from a decline of said request and an acceptance of said request in order to control the allies associated with said profiler, said acceptance serving to associate said investigator with said profiler as an ally to said profiler, as well as to associate said profiler with any allies of said investigator to create a hierarchy of allies to said profiler; and
an ally profile posted on said feature profile of said profiler, said ally profile comprising an access link to a feature profile of said ally, identification of and an access link to any said allies of said ally, and a subjective rating and characterization of said profiler provided by said ally.

2. The system of claim 1, further comprises a relationship stage defining function comprising:
two users involved in a relationship;
an initial pre-defined default stage of relationship between said two users;
one or more pre-defined successive stages of relationship said users may advance to from said default stage;
a set of rules governing and defining appropriate and inappropriate behavior within each of said stages of relationship;
a next stage identifier that one of said users may send to the other indicating a desire to advance to the next said successive stage in said relationship; and
a reciprocating next stage identifier sent from said user receiving said next stage identifier to said user sending said next stage identifier, said reciprocating next stage identifier confirming the advancement to said next stage.

3. The system of claim 1, wherein said ally association function further comprises a security and group blocking function comprising:
a block initiated by said profiler allowing said profiler to block said investigator from accessing and viewing said profiler's feature profile, said block based upon a violation of pre-defined rules of behavior; and
a share block operation, wherein said profiler shares said block with one or more allies of said profiler.

4. The system of claim 3, wherein said block, as shared with said allies, serves to notify and warn said allies of said block by said profiler.

5. The system of claim 1, wherein said ally association function further comprises a hide function, wherein said profiler can hide said profiler's feature profile from an investigator.

6. The system of claim 1, further comprising a verification function for verifying the identity and information of said users.

7. The system of claim 1, further comprising an authentication function that authenticates the identities of said users.

8. The system of claim 7, wherein said authentication function is carried out by an independent third party source.

9. The system of claim 1, wherein said users are comprised of individuals, entities, professionals, businesses, and non-profit organizations.

10. The system of claim 1, wherein said feature profile of said profiler comprises allies to the first degree, second degree, third degree and beyond, said second degree allies first in degree to said first degree allies of said profiler and second in degree to said profiler, said third degree allies first in degree to said second degree allies of said profiler and third in degree to said profiler.

11. The system of claim 1, wherein said allies function to verify said information provided by said profiler as posted on said feature profile of said profiler.

12. The system of claim 1, wherein said allies are capable of introducing, serving as liaison between, setting up a meeting between, and generally serving as the contact between said investigator and said profiler.

13. The system of claim 1, wherein said ally association function contemplates a relationship selected from an investigator to profiler, profiler to investigator, investigator to ally, ally to investigator, profiler to ally, ally to profiler, and ally to ally.

14. The system of claim 1, wherein said ally functions to witness to the information provided in said profiler's feature profile.

15. The system of claim 1, wherein said ally functions as a resource for investigators to contact in trying to establish a relationship with a profiler.

16. The system of claim 1, wherein said ally association function provides in said computer network-based environment, the interaction and contact possibilities of real space.

17. The system of claim 1, wherein said ally association function builds a community of users through the proliferation of said ally associations.

18. The system of claim 1, wherein said ally association function comprises a quick search mechanism, wherein said users, and said users'ally associates, may be searched simultaneously.

19. The system of claim 1, wherein said ally association function allows said profiler to request that one or more of said users become an ally to said profiler.

20. The system of claim 1, wherein said ally association function may be implemented in a computer network-based environment selected from the group consisting of online professional and labor promoting services, online dating and escort services, online information providing services, and any other in which a community of users may exist.

21. The system of claim 1, wherein said ally association function further comprises a group association function comprising:
one or more users interacting and participating with each other as a group due to one or more ally associations; and
a group leader to organize and lead the group.

22. The system of claim 21, wherein said group association function further comprises means for providing group to group interaction.

23. A computer network-based user-to-user ally association system comprising:
a server system comprising one or more servers;
a plurality of client computing devices in communication with said server system to comprise a network-based computer system, said plurality of client computing devices corresponding to a plurality of users, wherein said plurality of users may take on one of several roles, namely an investigator, a profiler, and an ally depending upon whether said users are accessing and viewing other users' profiles, said users' profiles are being accessed and viewed, and if said users are associated with other users, respectively;
a computer-readable medium containing instructions for controlling said network-based computer system to execute an ally association function, wherein a said user is associated with another said user as an ally, said computer-readable medium comprising code for directing a computer to:
support a plurality of user profiles corresponding to said plurality of users; display a feature profile of a profiler to an investigator;
receive a request from said investigator to become an ally associate of said profiler upon viewing said feature profile;
send said request to said profiler for approval, said profiler having the ability to choose from a decline of said request and an acceptance of said request in order to control the allies associated with said profiler;
receive a response from said profiler, said response comprising one of said acceptance or decline;
upon acceptance, associate said investigator as an ally of said profiler, as well as associate said profiler with any allies of said investigator to create a hierarchy of allies to said profiler;
display an ally profile on said feature profile of said profiler, said ally profile comprising an access link to a feature profile of said ally, identification of and an access link to any said allies of said ally, and a subjective rating and characterization of said profiler provided by said ally; and
proliferate said association function through other user-to-user ally associations to build a reference and witnessing hierarchy within said computer based-network.

24. The computer network-based user-to-user ally association system of claim 23, further comprising a relationship stage defining function.

25. The computer network-based user-to-user ally association system of claim 24, wherein said relationship stage defining function comprises a computer-readable medium containing instructions for controlling said network-based computer system to implement a system and method for defining the stages of a relationship and facilitating the advancement of stages in said relationship, said computer-readable medium comprising code for directing a computer to:
pre-define one or more stages of an online relationship between two or more users, said pre-defined stages comprising rules of appropriate and inappropriate behavior, said stages of said relationship advanced to by said two or more users sending reciprocal next stage notifiers;
route a next stage notifier to a receiving user as sent by a sending user; and
process a reciprocal response next stage notifier sent by said receiving user indicating an agreement to advance to the next stage in said relationship.

26. The computer network based user-to-user ally association system of claim 23, further comprising a security and group blocking function

27. The computer network-based user-to-user ally association system of claim 26, wherein said security and group blocking function comprises a computer-readable medium containing instructions for implementing within said network based computer system a system and method for providing said security and group blocking function, said computer-readable medium comprising code for directing a computer to:
receive a block notifier from a profiler, said block notifier comprising a block prohibiting a targeted investigator from accessing and viewing a feature profile of said profiler, said block based upon a violation of pre-defined rules of behavior;
process said block notifier;
initiate said block of said investigator; and
send notification of said block to any allies of said profiler to put each said ally on notice of said block.

28. The computer network-based user-to-use ally association system of claim 23, wherein said computer-readable medium further comprises code for directing a computer to:
control said computer network based system;
gather and store information pertaining to said plurality of users;
create user profiles for each of said plurality of users, said user profiles comprising one or more Web pages comprising said gathered and stored information pertaining to each user, respectively; and
display said user profiles within said computer network based system.

29. A method for associating a user with a profiler to establish said user as an ally to said profiler, said method comprising the steps of:
obtaining a plurality of users within an online community, said plurality of users taking on one of several roles, namely an investigator, a profiler, and an ally depending upon whether said users are accessing and viewing other users' profiles, said users' profiles are being accessed and viewed, and if said users are associated with other users, respectively;
accessing, as an investigator, a feature profile of a profiler;
initiating a request to become an ally of said profiler;
providing information about and rating, as part of said request, said profiler;
submitting said request to become an ally to said profiler for approval;
becoming an ally to said profiler upon said profiler's approval of said request;
adding said investigator as an ally to said feature profile of said profiler, said ally user serving as a voucher and confidant for said profiler, as well as a resource for other investigators within said community to utilize in seeking to pursue and establish a relationship with said profiler; and
creating an ally profile of said ally within said feature profile of said profiler, said ally profile comprising an access link to a feature profile of said ally, identification of and an access link to any said allies of said ally, and a subjective rating and characterization of said profiler provided by said ally.

30. The method of claim 29, further comprising a method for defining a stage of an online relationship and advancing through various stages of said relationship, said method comprising the steps of:
pre-defining one or more stages of an online relationship between two or more users, each of said stages comprising rules of appropriate and inappropriate behavior; and
advancing to the next stage in said relationship by said two or more said users sending reciprocal next stage notifiers.

31. The method of claim 29, further comprising the steps of:
providing a blocking feature, wherein said profiler may block any other of said users from viewing and accessing said profiler's said feature profile, said block based upon a violation by said user of pre-defined rules of behavior; and
sharing said block with said allies of said profiler so said allies are notified of said block.

32. The method of claim 29, further comprising a method for implementing a group association function within said system, said group association function comprising:
one or more users interacting and participating with each other as a group due to one or more ally associations;
a group leader to organize and lead the group; and
means for providing group to group interaction.

33. A computer program product for implementing within a computer network based system a method for associating an investigator with a profiler, said computer program product comprising:
a computer readable medium for providing computer program code means utilized to implement said method, wherein said computer program code means is comprised of executable code for implementing the steps comprised of:
obtaining a plurality of users within an online community, said plurality of users taking on one of several roles, namely an investigator, a profiler, and an ally depending upon whether said users are accessing and viewing other users' profiles, said users' profiles are being accessed and viewed, and if said users are associated with other users, respectively;
displaying to said investigator a feature profile of said profiler;
processing a request by said investigator to become an ally of said profiler;
receiving, as part of said request, information and ratings pertaining to said profiler from said investigator;
transmitting said request to said profiler for approval;
receiving a response from said profiler;
adding said investigator as an ally to said feature profile of said profiler, upon said approval by said profiler, said ally user serving as a voucher and confidant for said profiler, as well as a resource for other investigators within said community to utilize in seeking to pursue and establish a relationship with said profiler; and
creating an ally profile of said ally within said feature profile of said profiler, said ally profile comprising an access link to a feature profile of said ally, identification of and an access link to any said allies of said ally, and a subjective rating and characterization of said profiler provided by said ally.

34. A computer program product for implementing within a computer network-based system a method for forming and establishing relationships among users, said computer program product comprising:
a computer readable medium for providing computer program code means utilized to implement said method, wherein said computer program code means is comprised of executable code for implementing the steps comprised of:
obtaining a plurality of users within an online community, said plurality of users taking on one of several roles, namely an investigator, a profiler, and an ally depending upon whether said users are accessing and viewing other users' profiles, said users' profiles are being accessed and viewed, and if said users are associated with other users, respectively;
displaying to said investigator a feature profile of said profiler, said feature profiler comprising information about said profiler and at least one ally profile corresponding to an ally associated with said profiler; and
providing an ally association function, wherein one of said users is selectively associated with another one of said users as an ally, said ally association function activated when an investigator initiates a request to become an ally associate of a profiler upon viewing a feature profile of said profiler, said profiler having the ability to choose from a decline of said request and an acceptance of said request in order to control the allies associated with said profiler,
said acceptance serving to associate said investigator with said profiler as an ally to said profiler, as well as to associate said profiler with any allies of said investigator to create a hierarchy of allies to said profiler.

35. The computer program product of claim 34, wherein said step of providing an ally association function contemplates a relationship selected from an investigator to profiler, profiler to investigator, investigator to ally, ally to investigator, profiler to ally, and ally to profiler.

36. The computer program product of claim 34, wherein said computer program code means further comprises executable code for implementing the steps comprised of:
processing a request by an investigator to become an ally to either of said profiler and said allies of said profiler; and
establishing a desired ally association by adding and posting an ally profile on said featured profile of said profiler, said ally profile comprising an access link to a feature profile of said ally, identification of and an access link to any said allies of said ally, and a subjective rating and characterization of said profiler provided by said ally.

37. The computer program product of claim 34, wherein said computer program code means further comprises executable code for implementing the steps comprised of:
obtaining and processing an online association and relationship between two users, said users taking on one of several roles, namely an investigator, a profiler, and an ally depending upon whether said users are accessing and viewing other users' profiles, said users' profiles are being accessed and viewed, and if said users are associated with other users, respectively;
receiving a block notifier from a profiler, said block notifier comprising a block prohibiting a targeted investigator from accessing and viewing a feature profile of said profiler, said block based upon a violation of pre-defined rules of behavior;
processing said block notifier;
executing said block of said investigator; and
transmitting, at the request of said profiler, said block to any allies of said profiler to put each said ally on notice of said block.

38. The computer program product of claim 34, wherein said computer program code means further comprises executable code for implementing the steps comprised of:
providing an ally profile, wherein said ally profile comprises allies to the first degree, second degree, third degree and beyond, said second degree allies first in degree to said first degree allies of said profiler and second in degree to said profiler, said third degree allies first in degree to said second degree allies of said profiler and third in degree to said profiler.
